(19) United States
(12) Patent Application Publication
(10) Pub. No.: US 2013/0239456 A1
(43) Pub. Date: Sep. 19, 2013

(54) DECORATIVE FISHING ROD

(71) Applicant: Gary Leffler, Bonaparte, IA (US)

(72) Inventor: Gary Leffler, Bonaparte, IA (US)

(21) Appl. No.: 13/990,012

(22) PCT Filed: Nov. 29, 2011
(86) PCT No.: PCT/US11/62443

§ 371 Date: May 28, 2013

Related U.S. Application Data
(60) Provisional application No. 61/417,550, filed on Nov. 29, 2010.

(51) Int. Cl. A01K 87/00; A01K 87/04; A01K 87/08

(52) U.S. Cl. CPC A01K 87/00; A01K 87/08; A01K 87/04
USPC 43/23; 43/24

(57) ABSTRACT

A fishing rod assembly that has a handle with a first decorative design and a shaft having eyelets that have a second decorative design that is related to the first decorative design. In addition the fishing rod has a reel and accompanying decorative bobber that also present decorative designs that are related to the first and second decorative design.

### CROSS REFERENCE TO RELATED APPLICATION

This application claims the benefit of U.S. Provisional Application No. 61/417,550 filed Nov. 29, 2010.

### BACKGROUND OF THE INVENTION

This invention is directed toward a decorative fishing rod wherein the handle, eyelets, and shaft are related in design.

Fishing rods are well known in the art and come in a variety of shapes and sizes. There are a few fishing rods that have the design of a gun or a golf club, but these devices are complex in their construction, have many parts, and are generally cost prohibitive. In addition, existing rods are not designed to allow fishermen to support and promote a team, school, cause, organization, profession, hobby, or corporation. As a result, a need exists in the art for a device that addresses these deficiencies.

Therefore, an objective of this invention is to provide a fishing rod wherein the handle, eyelets, and shaft are related in design.

### BRIEF SUMMARY OF THE INVENTION

A fishing rod assembly that includes a handle having a first decorative design and a shaft secured to and extending from the handle. The shaft has a plurality of eyelets that have a second decorative design that is related to the first decorative design.

### BRIEF DESCRIPTION OF THE DRAWINGS

FIG. 1 is a side plan view of a fishing rod assembly;

FIG. 2 is a side plan view of a fishing rod assembly;

FIG. 3 is a side plan view of a fishing rod assembly; and

FIG. 4 is a side plan view of a decorative bobber for a fishing rod assembly.

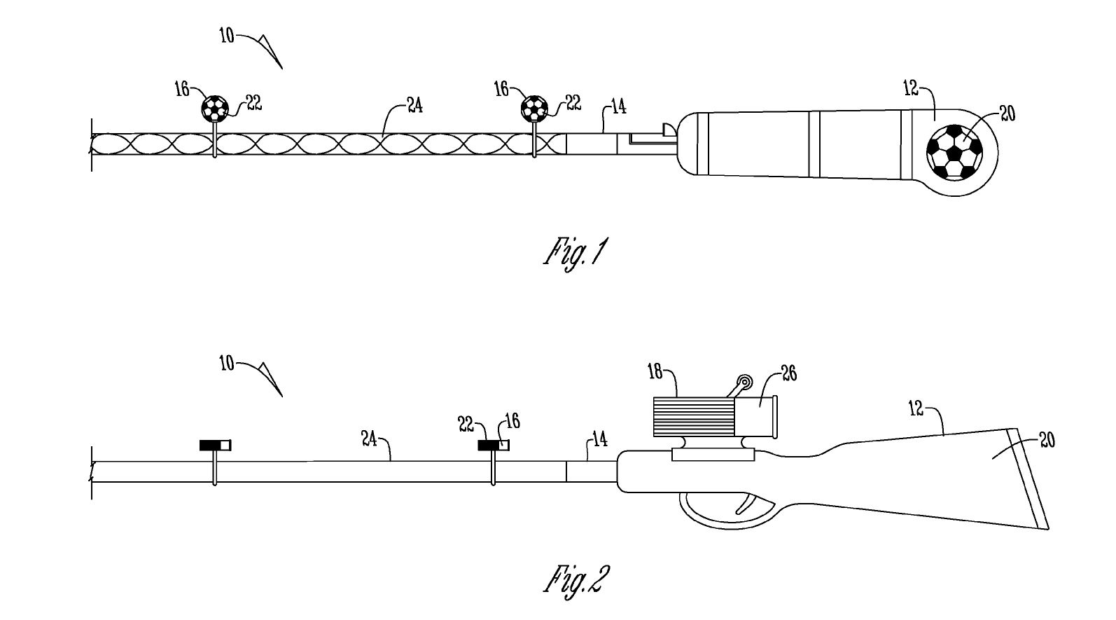

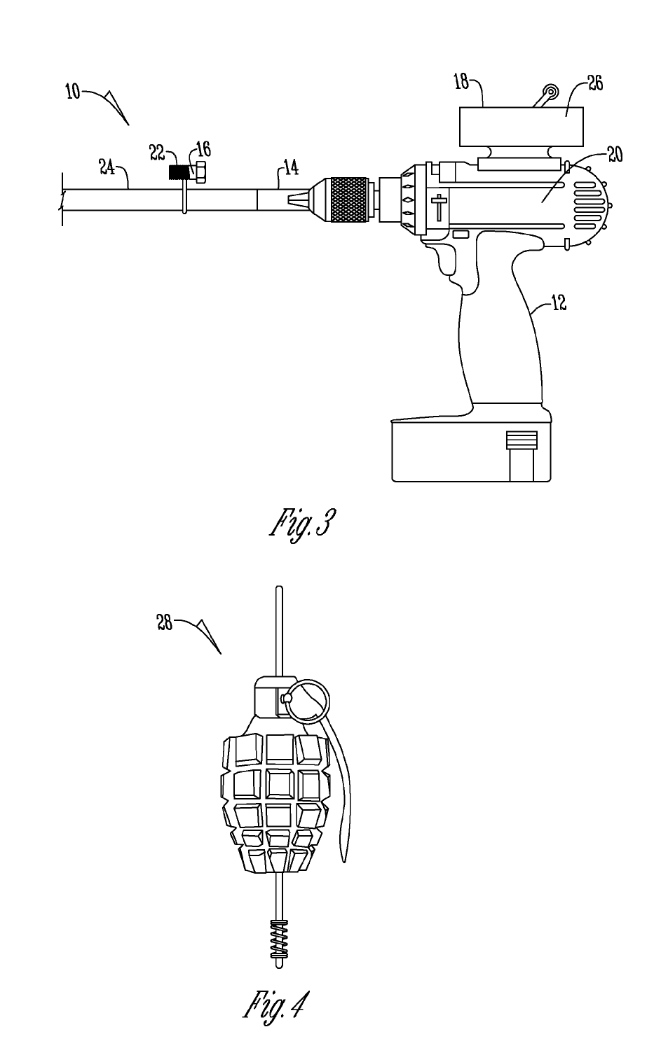

### DETAILED DESCRIPTION OF THE PREFERRED EMBODIMENTS

Referring to the figures, the fishing rod assembly 10 comprises a handle 12 attached to a shaft 14 with the shaft 14 having a plurality of eyelets 16 and having a reel 18 attached thereto. Preferably, the handle 12 is formed to have a first decorative design 20. The decorative design is of any size and shape such as, for example, a tool (i.e., drill, screw driver, snap on wrench, socket wrench, tape measure, or hammer); a sports item (i.e., baseball bat, any type of gun, hockey stick or a pool stick); a product (i.e., stick shift for a car or clutch for a motorcycle); a team mascot/emblem, or a corporate symbol. In addition, the handle 12 could include the colors and indicia such as names, symbols, and trademarks for entities such as schools, high school, collegiate and professional teams, organizations, individuals, or corporations. Thus, a decoration distinguishes from a typical fishing rod assembly by presenting objects not associated with the fishing rod assembly itself to be seen by outside observers.

The eyelets 16, which are attached to the shaft 14 in spaced relation, also have a second decorative design 22 that is related to the decorative design of the handle 12. As an example, if the handle 12 were in the shape of a stick shift or a motorcycle clutch, the eyelets 16 might have the design of a tire. In another example, if the handle 12 had the shape of any type of gun stock, the eyelet 16 might have the shape of a shotgun shell, bullet, or cartridge. In a still further example, if the handle 12 were in the shape of a baseball bat, the eyelets 16 could be in the shape of a baseball. Any combination is contemplated so long as the designs are related in concept.

The shaft 14, in one embodiment, has a third decorative design 24 and/or color that relate to the decorative design 22 of the eyelets 16 and/or the decorative design 20 of the handle 12. For example, if the decorative design 20 or 22 of the handle 12 and/or eyelets 16 is related to football, then the design 24 of the shaft 14 might be green with yardage markings. If the design 20 or 22 of the handle 12 and/or eyelets 16 is related to soccer, then the design 24 of the shaft 14 might have a net. In a still further example, if the design 20 or 22 of the handle 12 and/or eyelets 16 is for a tape measure, then the shaft 14 may be yellow with markings for inches and feet. In addition the shaft 14 may include colors and indicia such as names, symbols, and trademarks such as schools, teams, organizations, individuals or corporations. Any combination is contemplated so long as the design of the shaft 14 is related in concept to the design of the handle 12 and/or eyelets 16.

In addition, a fishing reel 10, having a decorative design 26, is attached to the handle 12. The design of the reel 18 is related to the design of the handle 12 and/or eyelets 16. For example, if the handle 12 and/or eyelets 16 are related to a shotgun the reel 18 may have the design of a shotgun shell.

Finally, the decorative rod is part of a kit that includes at least one decorative bobber 28. For example, as discussed above, if the handle 12 is a baseball bat the bobber 28 might be in the shape of a baseball in a team's colors with a team name or logo thereon. Any combination is contemplated so long as the design of the bobber 28 relates to the design of the handle 12, eyelets 16, shaft 14 and/or reel 18.

What is claimed is:

1. A fishing rod assembly comprising: a handle having a first decorative design; and a shaft secured to the handle and having a plurality of eyelets that have a second decorative design related to the first decorative design.

2. The fishing rod assembly of claim 1 wherein the first decorative design of the handle is a stick shift and the second decorative design of the eyelets are tires.

3. The fishing rod assembly of claim 1 wherein the first decorative design of the handle is a gun stock and the second decorative design of the eyelet is a shot gun shell.

4. The fishing rod assembly of claim 1 wherein the first decorative design of the handle is a baseball bat and the second decorative design of the eyelets are a shape of a baseball.

5. The fishing rod assembly of claim 1 wherein the shaft has a third decorative design related to the first and second decorative designs.

6. The fishing rod assembly of claim 5 wherein the first decorative design of the handle is a logo of a football team, the second decorative design of the eyelets are footballs and the third decorative design of the shaft is green with yard markings.

7. The fishing rod assembly of claim 1 wherein the first decorative design is a team logo.

8. The fishing rod assembly of claim 1 wherein the second decorative design is a sports item.

9. The fishing rod assembly of claim 1 further comprising a decorative bobber connected to a reel that is connected to the handle and having a decorative design related to the first and second decorative designs.

10. The fishing rod assembly of claim 9 where the reel has a decorative design related to the first and second decorative designs.
